(19) United States
(12) Patent Application Publication
(10) Pub. No.: US 2006/0164543 A1
(43) Pub. Date: Jul. 27, 2006

(54) Video encoding with skipping motion estimation for selected macroblocks

(76) Inventors: Iain Richardson, Westerton (GB); Yafan Zhao, Aberdeen (GB)

Correspondence Address: FULBRIGHT AND JAWORSKI LLP, 555 S. FLOWER STREET, 41ST FLOOR, LOS ANGELES, CA, 90071, US

(21) Appl. No.: 10/539,710

(22) PCT Filed: Dec. 16, 2003
(86) PCT No.: PCT/GB03/05526

§ 371 Date: Jan. 9, 2006

(30) Foreign Application Priority Data
Dec. 18, 2002 (GB) 0229354.6

(51) Int. Cl. H04N 7/12

(52) U.S. Cl. 348/390.1

(57) ABSTRACT

The computational complexity of video encoding is reduced by taking the decision whether to encode a region of a video frame or to skip the encoding prior to calculating whether any motion has occurred in respect of the same region in the previous frame. In one embodiment, the decision on whether to skip the encoding of a region is based o an estimate of the energy of pixel values in the region and/or en estimate of discrete cosine transform coefficients. In a further embodiment, the decision is based on an estimate of the distortion likely to occur if the region is no encoded.

The invention relates to video encoders and in particular to reducing the computational complexity when encoding video.

Video encoders and decoders (CODECs) based on video encoding standards such as H263 and MPEG-4 are well known in the art of video compression.

The development of these standards has led to the ability to send video over much smaller bandwidths with only a minor reduction in quality. However, decoding and, more specifically, encoding, requires a significant amount of computational processing resources. For mobile devices, such as personal digital assistants (PDA's) or mobile telephones, power usage is closely related to processor utilisation and therefore relates to the life of the battery charge. It is obviously desirable to reduce the amount of processing in mobile devices to increase the operable time of the device for each battery charge. In general-purpose personal computers, CODECs must share processing resources with other applications. This has contributed to the drive to reduce processing utilisation, and therefore power drain, without compromising viewing quality.

In many video applications, such as teleconferences, the majority of the area captured by the camera is static. In these cases, power resources or processor resources are being used unnecessarily to encode areas which have not changed significantly from a reference video frame.

The typical steps required to process the pictures in a video by an encoder such as one that is H263 or MPEG-4 Simple Profile compatible, are described as an example.

The first step requires that reference pictures be selected for the current picture. These reference pictures are divided into non-overlapping macroblocks. Each macroblock comprises four luminance blocks and two chrominance blocks, each block comprising 8 pixels by 8 pixels.

It is well known that the steps in the encoding process that typically require the greatest computational time are the motion estimation, the forward discrete cosine transform (FDCT) and the inverse discrete cosine transform (IDCT).

The motion estimation step looks for similarities between the current picture and one or more reference pictures. For each macroblock in the current picture, a search is carried out to identify a prediction macroblock in the reference picture which best matches the current macroblock in the current picture. The prediction macroblock is identified by a motion vector (MV) which indicates a distance offset from the current macroblock. The prediction macroblock is then subtracted from the current macroblock to form a prediction error (PE) macroblock. This PE macroblock is then discrete cosine transformed, which transforms an image from the spatial domain to the frequency domain and outputs a matrix of coefficients relating to the spectral sub-bands. For most pictures much of the signal energy is at low frequencies, which is what the human eye is most sensitive to. The formed DCT matrix is then quantized which involves dividing the DCT coefficients by a quantizer value and then rounding to the nearest integer. This has the effect of reducing many of the higher frequency coefficients to zeros and is the step that will cause distortion to the image. Typically, the higher the quantizer step size, the poorer the quality of the image. The values from the matrix after the quantizer step are then re-ordered by “zigzag” scanning. This involves reading the values from the top left-hand corner of the matrix diagonally back and forward down to the bottom right-hand corner of the matrix. This tends to group the zeros together which allows the stream to be efficiently run-level encoded (RLE) before eventually being converted into a bitstream by entropy encoding. Other “header” data is usually added at this point.

If the MV is equal to zero and the quantized DCT coefficients are all equal to zero then there is no need to include encoded data for the macroblock in the encoded bitstream. Instead, header information is included to indicate that the macroblock has been “skipped”.

U.S. Pat. No. 6,192,148 discloses a method for predicting whether a macroblock should be skipped prior to the DCT steps of the encoding process. This method decides whether to complete the steps after the motion estimation if the MV has been returned as zero, the mean absolute difference of the luminance values of the macroblock is less than a first threshold and the mean absolute difference of the chrominance values of the macroblock is less than a second threshold.

For the total encoding process the motion estimation and the FDCT and IDCT are typically the most processor intensive. The prior art only predicts skipped blocks after the step of motion estimation and therefore still contains a step in the process that can be considered processor intensive.

The present invention discloses a method to predict skipped macroblocks that requires no motion estimation or DCT steps.

According to the present invention there is provided a method of encoding video pictures comprising the steps of:
dividing the picture into regions;
predicting whether each region requires processing through further steps, said predicting step comprising comparing one or more statistical measures with one or more threshold values for each region.

Hence, the invention avoids unnecessary use of resources by avoiding processor intensive operations where possible.

The further steps preferably include motion estimation and/or transform processing steps.

Preferably the transform processing step is a discrete cosine transform processing step.

A region is preferably a non-overlapping macroblock.

A macroblock is preferably a sixteen by sixteen matrix of pixels.

Preferably, one of the statistical measures is whether an estimate of the energy of some or all pixel values of the macroblock, optionally divided by the quantizer step size, is less than a predetermined threshold value.

Alternatively or further preferably, one of the statistical measures is whether an estimate of the values of certain discrete cosine transform coefficients for one or more sub-blocks of the macroblock, is less than a second threshold value.

Alternatively, one of the statistical measures is whether an estimate of the distortion due to skipping the macroblock is less than a predetermined threshold value.

Preferably, the estimate of distortion is calculated by deriving one or more statistical measures from some or all pixel values of one or more previously coded macroblocks with respect to the macroblock.

The estimate of distortion may be calculated by subtracting an estimate of the sum of absolute differences of luminance values of a coded macroblock with respect to a previously coded macroblock (SAEₙₒₛₖᵢₚ) from the sum of absolute differences of luminance values of a skipped macroblock with respect to a previously coded macroblock (SAEₛₖᵢₚ).

SAEₙₒₛₖᵢₚ may be estimated by a constant value K or, in a more accurate method, by the sum of absolute differences of luminance values of a previously coded macroblock and if there is no previously coded macroblock by a constant value K.

Further preferably, the method of encoding pictures may be performed by a computer program embodied on a computer usable medium.

Further preferably, the method of encoding pictures may be performed by electronic circuitry.

The estimate of the values of certain discrete cosine transform coefficients may involve:

dividing the sub-blocks into four equal regions;

calculating the sum of absolute differences of the residual pixel values for each region of the sub-block, where the residual pixel value is a corresponding reference (previously coded) pixel luminance value subtracted from the current pixel luminance value;

estimating the low frequency discrete cosine transform coefficients for each region of the sub-blocks, such that:
Y₀₁=abs(A+C−B−D)
Y₁₀=abs(A+B−C−D)
Y₁₁=abs(A+D−B−C)
where Y₀₁, Y₁₀ and Y₁₁ represent the estimations of three low frequency discrete cosine transform coefficients and A, B, C and D represent the sum of absolute differences of each of the regions of the sub-block where A is the top left hand corner, B is the top right hand corner, C is the bottom left hand corner and D is the bottom right hand corner; and
selecting the maximum value of the estimate of the discrete cosine transform coefficients from all the estimates calculated.

It should be appreciated that, in the art, referring to pixel values refers to any of the three components that make up a colour pixel, namely, a luminance value and two chrominance values. In some instances, “sample” value is used instead of pixel value to refer to one of the three component values and this should be considered interchangeable with pixel value.

It also should be appreciated that a macroblock can be any region of pixels, of a particular size, within the frame of interest.

The invention will now be described, by way of example, with reference to the figures of the drawings in which:

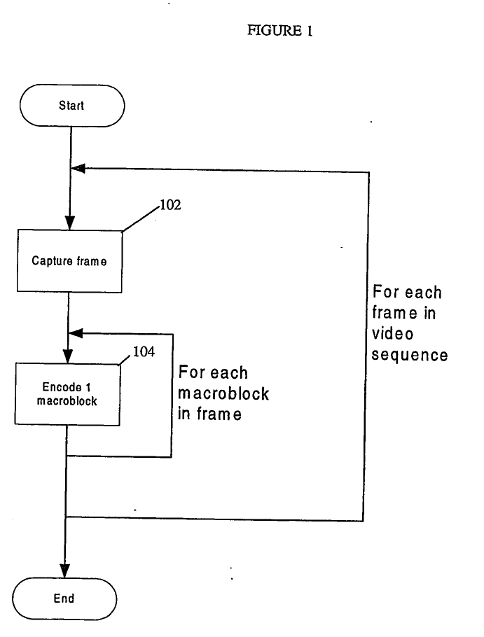

FIG. 1 shows a flow diagram of a video picture encoding process.

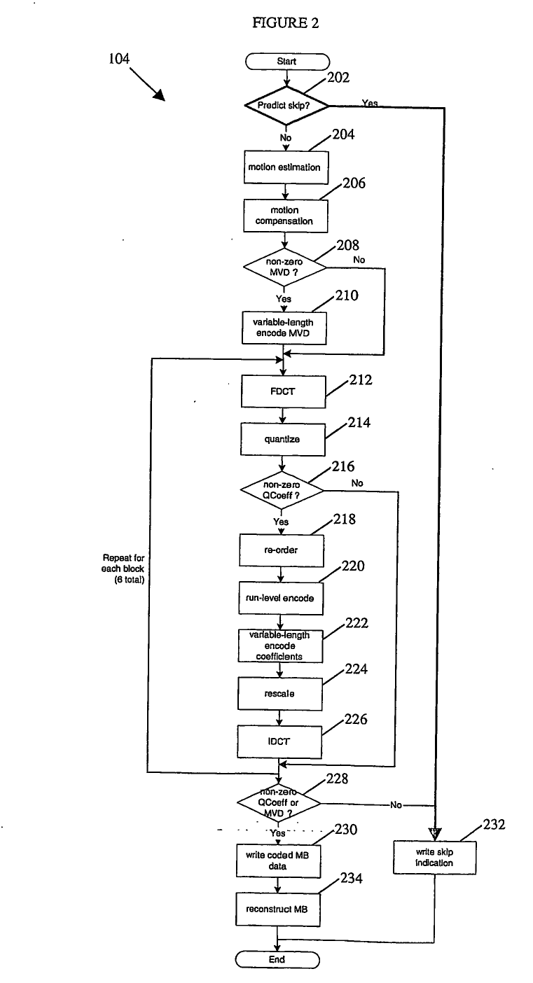

FIG. 2 shows a flow diagram of a macroblock encoding process

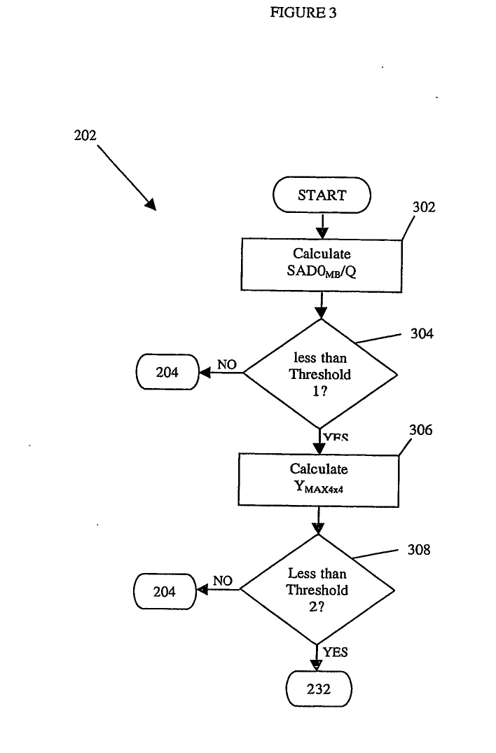

FIG. 3 shows a flow diagram of a prediction decision process

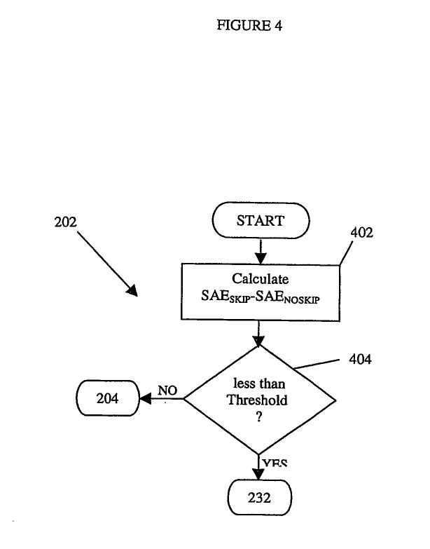

FIG. 4 shows a flow diagram of an alternative prediction decision process

With reference to FIG. 1, a first step 102 reads a picture frame in a video sequence and divides it into non-overlapping macroblocks (MBs). Each MB comprises four luminance blocks and two chrominance blocks, each block comprising 8 pixels by 8 pixels. Step 104 encodes the MB as shown in FIG. 2.

With reference to FIG. 2, a MB encoding process is shown 104, where a decision step 202 is performed before any other step.

The current H263 encoding process currently teaches that each ME in the video encoding process typically goes through the steps 204 to 226 or equivalent processes, in the order shown in FIG. 2 or in a different order. Motion estimation step 204 identifies one or more prediction MB(s) each of which is defined by a MV indicating a distance offset from the current MB and a selection of a reference picture. Motion compensation step 206 subtracts the prediction MB from the current MB to form a Prediction Error (PE) MIB. If the value of MV requires to be encoded (step 208), then MV is entropy encoded (step 210) optionally with reference to a predicted MV.

Each block of the PE MB is then forward discrete cosine transformed (FDCT) 212 which outputs a block of coefficients representing the spectral sub-bands of each of the PE blocks. The coefficients of the FDCT block are then quantized (for example through division by a quantizer step size) 214 and then rounded to the nearest integer. This has the effect of reducing many of the coefficients to zero. If there are any non-zero quantized coefficients (Qcoeff) 216 then the resulting block is entropy encoded by steps 218 to 222.

In order to form a reconstructed picture for further predictions, the quantized coefficients (QCoeff) are re-scaled (for example by multiplication by a quantizer step size) 224 and transformed with an inverse discrete cosine transform (IDCT) 226. After the IDCT the reconstructed PE MB is added to the reference MB and stored for further prediction.

The decision step 228 looks at the output of the prior processes and if the MV is equal to zero and all the Qcoeffs are zero then the encoded information is not written to the bitstream but a skip MB indication is written instead. This means that all the processing time that has been used to encode the MB has not been necessary because the MB is regarded as similar to or the same as the previous MB.

As one embodiment of the invention, in FIG. 2 decision step 202 predicts whether the current MB is likely to be skipped, that is that after the process steps 202-226, the MB is not coded but a skip indication is written instead. If the Decision step 202 does predict that the MB would be skipped the MB is not passed on to the step 204 and the following process steps but skip information is passed directly to step 232.

With reference to FIG. 3, a flow diagram is shown of the decision to skip the MB 202.

MBs that are skipped have zero MV and QCoeff. Both of these conditions are likely to be met if there is a strong similarity between the current MB and the same MB position in the reference frame. The energy of a residual MB formed by subtracting the reference MB, without motion compensation, from the current MB is approximated by the sum of absolute differences for the luminance part of the MB with zero displacement (SAD0_{MB}) given by:

$$SAD {0}_{MB} = {\sum }_{i = 0}^{15} {\sum }_{j = 0}^{15} \vert {C}_{C} ( i , j ) - {C}_{P} ( i , j ) \vert \qquad Equation 1$$

C_{C}(i,j) and Cₚ(i,j) are luminance samples from an MB in the current frame and in the same position in the reference frame, respectively.

The relationship between SAD0_{MB} and the probability that the MB will be skipped also depends on the quantizer step size since a higher step size typically results in an increased proportion of skipped MBs.

A comparison of the calculation SAD0_{MB} (optionally divided by the quantizer step size (Q)) 302 to a first threshold value gives a first comparison step 304. If the calculated value is greater than a first threshold value then the MB is passed to step 204 and enters a normal encoding process. If the calculated value is less than a first threshold value then a second calculation is performed 306.

Step 306 performs additional calculations on the residual MB. Each 8×8 luminance block is divided into four 4×4 blocks. A, B, C and D (Equation 2) are the SAD values of each 4×4 block and R(i,j) are the residual pixel values without motion compensation.

$$A = {\sum }_{i = 0}^{3} {\sum }_{j = 0}^{3} \vert R ( i , j ) \vert \\ B = {\sum }_{i = 0}^{3} {\sum }_{j = 3}^{7} \vert R ( i , j ) \vert \\ C = {\sum }_{i = 4}^{7} {\sum }_{j = 0}^{3} \vert R ( i , j ) \vert \\ D = {\sum }_{i = 4}^{7} {\sum }_{j = 4}^{7} \vert R ( i , j ) \vert \qquad Equation 2$$

Y₀₁, Y₁₀ and Y₁₁ (Equation 3) provide a low-complexity estimate of the magnitudes of the three low frequency DCT coefficients coeff(0,1), coeff(1,0) and coeff(1,1) respectively. If any of these coefficients is large then there is a high probability that the MB should not be skipped. Y4×4_{block} (Equation 4) is therefore used to predict whether each block may be skipped. The maximum for the luminance part of a macroblock is calculated using Equation 5.
Y₀₁=abs(A+C−B−D)
Y₁₀=abs(A+B−C−D)
Y₁₁=abs(A+D−B−C) Equation 3
Y4×4_{block}=MAX(Y₀₁, Y₁₀, Y₁₁) Equation 4
Y4×4ₘₐₓ=MAX(Y4×4_{block1},Y4×4_{block2},Y4×4_{block3},Y4×4_{block4}) Equation 5

The calculated value of Y4×4ₘₐₓ is compared with a second threshold 308. If the calculated value is less than a second threshold then the MB is skipped and the next step in the process is 232. If the calculated value is greater than a second threshold then the MB is passed to step 204 and the subsequent steps for encoding.

These steps typically have very little impact on computational complexity. SAD0_{MB} is normally computed in the first step of any motion estimation algorithm and so there is no extra calculation required. Furthermore, the SAD values of each 4×4 block (A, B, C and D in Equation 2) may be calculated without penalty if SAD0_{MB} is calculated by adding together the values of SAD for each 4×4-sample sub-block in the MB.

The additional computational requirements of the classification algorithm are the operations in Equations 3, 4 and 5 and these are typically not computationally intensive.

With reference to FIG. 4, a flow diagram is shown in which a further embodiment of the decision to skip the MB 202 is described.

In the previous embodiment (FIG. 3), the decision to skip the MB 202 was based on the luminance of the current MB compared to the reference MB. In the present embodiment, the decision to skip the MB 202 is based on the estimated distortion that would be caused due to skipping the MB.

When a decoder decodes a MB, the coded residual data is decoded and added to motion-compensated reference frame samples to produce a decoded MB. The distortion of a decoded MB relative to the original, uncompressed MB data can be approximated by Mean Squared Error (MSE). MSE for the luminance samples aᵢⱼ of a decoded MB, compared with the original luminance samples bᵢⱼ, is given by:

$${MSE}_{MB} = \frac{1}{16 \cdot 16} {\sum }_{i , j} {( {a}_{ij} - {b}_{ij} )}^{2} \qquad Equation 6$$

Define MSEₙₒₛₖᵢₚ as the luminance MSE for a macroblock that is coded and transmitted and define MSEₛₖᵢₚ as the luminance MSE for a MB that is skipped (not coded). When a MB is skipped, the MB data in the same position in the reference frame is inserted in that position by the decoder. For a particular MB position, an encoder may choose to code the MB or to skip it. The difference in distortion, MSE_{diff}, between skipping or coding the MB is defined as:
MSE_{diff}=MSEₛₖᵢₚ−MSEₙₒₛₖᵢₚ Equation 7

If MSE_{diff} is zero or has a low value, then there is little or no “benefit” in coding the MB since a very similar reconstructed result will be obtained if the MB is skipped. A low value of MSE_{diff} will include MBs with a low value of MSEₛₖᵢₚ where the MB in the same position in the reference frame is a good match for the current MB. A low value of MSE_{diff} will also include MBs with a high value of MSEₙₒₛₖᵢₚ where the decoded, reconstructed MB is significantly different from the original due to quantization distortion.

The purpose of selectively skipping MBs is to save computation. MSE is not typically calculated in an encoder and so an additional computational cost would be required to calculate Equation 7. Sum of Absolute Errors (SAE) for the luminance samples of a decoded MB is given by:

$${SAE}_{MB} = {\sum }_{i , j} \vert {a}_{ij} - {b}_{ij} \vert \qquad Equation 8$$

SAE is approximately monotonically increasing with MSE and so is a suitable alternative measure of distortion to MSE. Therefore SAEdiff is used, the difference in SAE between a skipped MB and a coded MB, as an estimate of the increase in distortion due to skipping a MB:
SAE_{diff}=SAEₛₖᵢₚ−SAEₙₒₛₖᵢₚ Equation 9

SAEₛₖᵢₚ is the sum of absolute errors between the uncoded MB and the luminance data in the same position in the reference frame. This is typically calculated as the first step of a motion estimation algorithm in the encoder and is usually termed SAE₀₀. Therefore, SAEₛₖᵢₚ is readily available at an early stage of processing of each MB.

SAEₙₒₛₖᵢₚ is the SAE of a decoded MB, compared with the original uncoded MB, and is not normally calculated during coding or decoding. Furthermore, SAEₙₒₛₖᵢₚ cannot be calculated if the MB is actually skipped. A model for SAEₙₒₛₖᵢₚ is therefore required in order to calculate Equation 9.

A first model is as follows:
SAEₙₒₛₖᵢₚ=K (where K is a constant).

Which follows that SAE_{diff} is calculated as:
SAE_{diff}=SAEₛₖᵢₚ−K Equation 10

This model is computationally simple but is unlikely to be accurate because there are many MBs that do not fit a simple linear trend.

An alternative model is as follows:
SAEₙₒₛₖᵢₚ(i,n)=SAEₙₒₛₖᵢₚ(i,n−1)

Where i is the current MB number, n is the current frame and n−1 is the previous coded frame.

This model requires the encoder to compute SAEₙₒₛₖᵢₚ, a single calculation of Equation 8 for each coded MB, but provides a more accurate estimate of SAEₙₒₛₖᵢₚ for the current MB. If MB(i,n−1) is a MB that was skipped, then SAEₙₒₛₖᵢₚ(i,n−1) cannot be calculated and it is necessary to revert to first model.

Based on Equation 9 and using the models described above, two algorithms for selectively skipping and therefore not processing MBs are as follows:

Algorithm (1):
if (SAE₀₀−K)<T
   skip current MB
else
   code current MB

Algorithm (1) uses a simple approximation for SAEₙₒₛₖᵢₚ but is straightforward to implement.

Algorithm (2):
if (MB(i,n−1) has been coded)
   SAEₙₒₛₖᵢₚ{estimate}=SAEₙₒₛₖᵢₚ(i,n−1)
else
   SAEₙₒₛₖᵢₚ{estimate}=K
if (SAE₀₀−SAEₙₒₛₖᵢₚ{estimate})<T
   skip current MB
else
   code current MB

Algorithm (2) provides a more accurate estimate of SAEₙₒₛₖᵢₚ but requires calculation and storage of SAEₙₒₛₖᵢₚ after coding of each non-skipped MB. In both algorithms, a threshold parameter T controls the proportion of skipped MBs. A higher value of T should result in an increased number of skipped MBs but also in an increased distortion due to incorrectly skipped MBs.

Improvements and modifications to the method of prediction may be incorporated in the foregoing without departing from the scope of the present invention.

For example, SAEₙₒₛₖᵢₚ could be estimated by a combination or even a weighted combination of the sum of absolute differences of luminance values of one or more previously coded macroblocks. In addition, SAEₙₒₛₖᵢₚ could be estimated by another statistical measure such as sum of squared errors or variance.

1. A method of encoding video pictures comprising the steps of:
dividing the picture into regions;
predicting whether each region requires processing through further steps, said predicting step comprising comparing one or more statistical measures with one or more threshold values for each region.

2. A method as claimed in claim 1, wherein the further steps include motion estimation.

3. A method as claimed in claim 1 wherein the further steps include transform processing.

4. A method as claimed in claim 3, wherein the transform processing step is a discrete cosine transform processing step.

5. A method as claimed in claim 1, wherein a region is a non-overlapping macroblock.

6. A method as claimed in claim 5, wherein a macroblock is a sixteen by sixteen matrix of pixels.

7. A method as claimed in claim 5, wherein one of the statistical measures is whether an estimate of the energy of some or all pixel values of the macroblock is less than a first predetermined threshold value.

8. A method as claimed in claim 7, wherein the estimate of energy is divided by a quantizer step size before being compared to the first threshold value.

9. A method as claimed in claim 7, wherein one of the statistical measures is whether an estimate of the values of certain discrete cosine transform coefficients for one or more sub-blocks of the macroblock, is less than a second predetermined threshold value.

10. A method as claimed in claim 9, wherein the estimate of the values of certain discrete cosine transform coefficients comprises:
dividing the sub-blocks into four equal sub-regions;
calculating a sum of absolute differences of residual pixel values for each sub-region of the sub-block, where the residual pixel value is a corresponding previously coded pixel luminance value subtracted from a corresponding pixel luminance value of the macroblock;
estimating the low frequency discrete cosine transform coefficients for each region of the sub-blocks, such that:
Y₀₁=abs(A+C−B−D)
Y₁₀=abs(A+B−C−D)
Y₁₁=abs(A+D−B−C)
where Y₀₁, Y₁₀ and Y₁₁ represent the estimations of three low frequency discrete cosine transform coefficients and A, B, C and D represent the sum of absolute differences of each of the regions of the sub-block where A is the top left hand corner, B is the top right hand corner, C is the bottom left hand corner and D is the bottom right hand corner; and
selecting the maximum value of the estimate of the discrete cosine transform coefficients from all the estimates calculated.

11. A method as claimed in claim 5, wherein one of the statistical measures is whether an estimate of distortion due to skipping the macroblock is less than a third predetermined threshold value.

12. A method as claimed in claim 11, wherein the estimate of distortion is calculated by deriving one or more statistical measures from some or all pixel values of one or more previously coded macroblocks with respect to the macroblock.

13. A method as claimed in claim 11, wherein, the estimate of distortion is calculated by subtracting an estimate of the sum of absolute differences of luminance values of a coded macroblock with respect to a previously coded macroblock (SAEₙₒₛₖᵢₚ) from the sum of absolute differences of luminance values of a skipped macroblock with respect to a previously coded macroblock (SAEₛₖᵢₚ).

14. A method as claimed in claim 13, wherein SAEₙₒₛₖᵢₚ is estimated by a constant value K.

15. A method as claimed in claim 13, wherein SAEₙₒₛₖᵢₚ is estimated by the sum of absolute differences of luminance values of a previously coded macroblock or if there is no previously coded macroblock by a constant value K.

16. A method of encoding pictures, as claimed in claim 1, performed by a computer program embodied on a computer usable medium.

17. A method of encoding pictures, as claimed in claim 1, performed by electronic circuitry.
